(19) United States
(12) Patent Application Publication
(10) Pub. No.: US 2022/0000101 A1
(43) Pub. Date: Jan. 6, 2022

(54) ANTIMICROBIAL CLEANING CLOTH AND A METHOD AND SYSTEM FOR MANUFACTURING THE SAME

(71) Applicant: NOAM URIM ENERPRISES (1993) LTD., Kibbutz Urim (IL)

(72) Inventor: Orly PORAT, Lehavim (IL)

(21) Appl. No.: 17/291,528

(22) PCT Filed: Jan. 16, 2020
(86) PCT No.: PCT/IL2020/050073

§ 371 Date: May 5, 2021

Related U.S. Application Data
(60) Provisional application No. 62/792,924, filed on Jan. 16, 2019.

(51) Int. Cl. A01N 25/34; D04H 1/4234; D04H 1/4258; D04H 1/4291; A47L 13/16; A01N 59/20

(52) U.S. Cl. CPC A01N 25/34; D04H 1/4234; D04H 1/4258; D10B 2401/13; A47L 13/16; A01N 59/20; D04H 1/4291

(57) ABSTRACT

The present subject matter provides an antimicrobial cleaning cloth, including: nonwoven fabric fibers; and copper fibers. A method for manufacturing the antimicrobial cleaning cloths includes: mixing nonwoven fabric fibers and copper fibers; carding the nonwoven fabric fibers and copper fibers; cross-lapping the nonwoven fabric fibers and copper fibers; needle-punching the nonwoven fabric fibers and copper fibers to form a nonwoven fabric comprising copper fibers; slitting the nonwoven fabric comprising copper fibers to form nonwoven fabric sheets; winding the nonwoven fabric sheets to form nonwoven fabric sheet rolls; and cutting the nonwoven fabric sheet rolls to antimicrobial cleaning cloths. A system for manufacturing the antimicrobial cleaning cloth and additional embodiments of the antimicrobial cleaning cloth, the method of manufacturing the same and the system for manufacturing the same are disclosed herein as well.

### CROSS-REFERENCE TO RELATED APPLICATION

This application claims priority to U.S. Provisional Patent Application No. 62/792,924, filed Jan. 16, 2019, the entire contents of which is incorporated herein by reference in its entirety.

### FIELD

The present subject matter relates to cleaning cloths. More particularly, the present subject matter relates to antimicrobial cleaning cloths.

### BACKGROUND

Cleaning cloth are generally wet for long periods of time. The humidity of the cleaning cloth encourages presence of microbes, especially bacteria and fungi, in the cleaning cloths. Usage of cleaning cloths containing microbes can be a source for contamination with pathogenic microbes.

### SUMMARY

Unless otherwise defined, all technical and scientific terms used herein have the same meaning as commonly understood by one of ordinary skill in the art to which this subject matter belongs. Although methods and materials similar or equivalent to those described herein can be used in the practice or testing of the present subject matter, suitable methods and materials are described below. In case of conflict, the patent specification, including definitions, will control. In addition, the materials, methods, and examples are illustrative only and not intended to be limiting.

According to one aspect of the present subject matter, there is provided an antimicrobial cleaning cloth comprising: nonwoven fabric fibers; and copper fibers.

According to one embodiment, the nonwoven fabric fibers comprising viscose fibers, polyethylene terephthalate fibers, and co-polyethylene terephthalate fibers.

According to another embodiment, the nonwoven fabric fibers comprising viscose fibers, and polypropylene fibers.

According to yet another embodiment, the nonwoven fabric fibers comprising viscose fibers, and thermally bonded fibers.

According to still another embodiment, the antimicrobial cleaning cloth further comprising active materials.

According to another aspect of the present subject matter, there is provided a method for manufacturing antimicrobial cleaning cloths, the method comprising: mixing nonwoven fabric fibers and copper fibers; carding the nonwoven fabric fibers and copper fibers; cross-lapping the nonwoven fabric fibers and copper fibers; needle-punching the nonwoven fabric fibers and copper fibers to form a nonwoven fabric comprising copper fibers; slitting the nonwoven fabric comprising copper fibers to form nonwoven fabric sheets; winding the nonwoven fabric sheets to form nonwoven fabric sheet rolls; and cutting the nonwoven fabric sheet rolls to antimicrobial cleaning cloths.

According to one embodiment, the method for manufacturing antimicrobial cleaning cloths further comprising after the needle-punching the nonwoven fabric fibers and copper fibers to form a nonwoven fabric comprising copper fibers—impregnating the nonwoven fabric comprising copper fibers with active materials.

According to another embodiment, the method for manufacturing antimicrobial cleaning cloths further comprising after the impregnating the nonwoven fabric comprising copper fibers with active materials—drying the nonwoven fabric.

According to yet another embodiment, the drying of the nonwoven fabric is performed at a temperature in a range of substantially 120-165° C.

According to still another embodiment, the method for manufacturing antimicrobial cleaning cloths further comprising after the cutting the nonwoven fabric sheet rolls to antimicrobial cleaning cloths—packaging the antimicrobial cleaning cloths.

According to yet another aspect of the present subject matter, there is provided a system for manufacturing antimicrobial cleaning cloths comprising: a fiber feeding element configured to feed nonwoven fabric fibers and copper fibers into a carding element; a carding element after the fiber feeding element, the carding element configured to card the nonwoven fabric fibers and copper fibers; a cross-lapping element after the carding element, the cross-lapping element 30 configured to cross-lap the nonwoven fabric fibers and copper fibers; a needle-punching element after the cross-lapping element, the needle-punching element configured to needle-punch the nonwoven fabric fibers and copper fibers to form a nonwoven fabric comprising copper fibers; a slitting element after the needle-punching element, the slitting element configured to slit the nonwoven fabric comprising copper fibers to form nonwoven fabric sheets; and a winding element after the slitting element, the winding element configured to wind the nonwoven fabric sheets to form nonwoven fabric sheet rolls.

According to one embodiment, the system for manufacturing antimicrobial cleaning cloths further comprising at least one impregnating element after the needle-punching element, the at least one impregnating element configured to impregnate the nonwoven fabric with active materials.

According to another embodiment, the system for manufacturing antimicrobial cleaning cloths further comprising a drying element after the impregnating element, the drying element configured to dry the nonwoven fabric after impregnating the nonwoven fabric.

According to yet another embodiment, the system for manufacturing antimicrobial cleaning cloths further comprising a cutting element after the winding element, the cutting element configured to cut the nonwoven fabric sheet rolls to antimicrobial cleaning cloths.

According to still another embodiment, the system for manufacturing antimicrobial cleaning cloths of claim 14, further comprising a packaging element after the cutting element, the packaging element configured to package the antimicrobial cleaning cloths.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding, the description taken with the drawings making apparent to those skilled in the art how several forms can be embodied in practice.

In the drawings:

FIG. 1 schematically illustrates, according to an exemplary embodiment, a block diagram of a system for manufacturing antimicrobial cleaning cloths.

### DESCRIPTION OF THE PREFERRED EMBODIMENTS

Before explaining at least one embodiment in detail, it is to be understood that the subject matter is not limited in its application to the details of construction and the arrangement of the components set forth in the following description or illustrated in the drawings. The subject matter is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts. The drawings are generally not to scale.

For clarity, non-essential elements were omitted from some of the drawings.

The present subject matter provides an antimicrobial cleaning cloth configured to prevent growth and accumulation of microbes in the antimicrobial cleaning cloth. Therefore, the antimicrobial cleaning cloth of the present subject matter solves the problem of presence of microbes, especially bacteria and fungi, in cleaning cloths that are wet, namely containing humidity, for long periods of time.

According to one embodiment, the antimicrobial cleaning cloth is configured to be used for cleaning, for example but not limited to, general cleaning, surface cleaning like kitchen or bathroom surface cleaning, floor cleaning and the like.

The term “microbes” as disclosed herein refers to any microbial organism known in the art, for example but not limited to, bacteria, fungi, molds, eukaryotic microorganisms and the like.

The term “antimicrobial” as disclosed herein refers to prevention of growth, development, accumulation, or presence in an object, for example a cleaning cloth, of any microbial organism known in the art, for example but not limited to, bacteria, fungi, molds, eukaryotic microorganisms and the like.

According to one embodiment, the antimicrobial cleaning cloth comprises: nonwoven fabric fibers, namely fibers that are configured to be used in manufacturing of a nonwoven fabric; and copper fibers.

According to one embodiment, the antimicrobial cleaning cloth is made of nonwoven fabric comprising fibers that are configured to be used in manufacturing a nonwoven fabric. Any type of nonwoven fabric known in the art is under the scope of the present subject matter. Generally, a nonwoven fabric is a fabric-like material made of staple (short) fibers and long fibers, bonded together by chemical, mechanical, heat or solvent treatment.

According to one embodiment, the nonwoven fabric of which the antimicrobial cleaning cloth is made is manufactured by any method known in the art. According to a preferred embodiment, the nonwoven fabric of which the antimicrobial cleaning cloth is made is manufactured by a needle punching method.

According to one embodiment, copper fibers are configured to provide antimicrobial activity to the antimicrobial cleaning cloth. According to one embodiment, the copper fibers entirely comprises copper. According to another embodiment, the copper fibers partially comprise copper. According to a preferred embodiment, the copper fibers confer antibacterial and antifungal activity to the antimicrobial cleaning cloth. According to another preferred embodiment, the copper fibers decrease substantially the amount of microbes in the antimicrobial cleaning cloth. According to yet another preferred embodiment, the copper fibers decrease a high percentage of the microbes in the antimicrobial cleaning cloth. According to one embodiment, any relative amount, for example in percent, of copper fibers in the antimicrobial cleaning cloth that confers an antimicrobial activity, preferably antibacterial and antifungal activity, to the antimicrobial cleaning cloth is under the scope of the present subject matter. According to another embodiment, the relative amount of copper fibers in the antimicrobial cleaning cloth is in the range of substantially 1-29% (w/w). According to yet another embodiment, the relative amount of copper fibers in the antimicrobial cleaning cloth is in the range of substantially 1-29% (w/w). According to still another embodiment, the relative amount of copper fibers in the antimicrobial cleaning cloth can be any one of substantially 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, and 29% (w/w).

According to one embodiment, the nonwoven fabric fibers are suitable for the manufacturing of cleaning cloths in general, and antimicrobial cleaning cloths in particular. According to another embodiment, the nonwoven fabric fibers are types of fibers that allow sticking of the nonwoven fabric fibers. According to yet another embodiment, the nonwoven fabric fibers are types of fibers that confer to the antimicrobial cleaning cloth a desired degree of softness. According to a still another embodiment, the nonwoven fabric fibers are types of fibers that confer to the antimicrobial cleaning cloth a desired degree of absorbability. According to a further embodiment, the nonwoven fabric fibers are type of fibers that confer to the antimicrobial cleaning cloth a desired color.

According to a one embodiment, the nonwoven fabric fibers comprise viscose fibers, polyethylene terephthalate (PET) fibers, and co-polyethylene terephthalate (CO-PET) fibers. According to another embodiment, the nonwoven fabric fibers comprise substantially 0-85% (w/w) viscose fibers, 0-60% (w/w) polyethylene terephthalate (PET) fibers of the entire fiber content of the antimicrobial cleaning cloth, and substantially 0-50% (w/w) co-polyethylene terephthalate (CO-PET) of the entire fiber content of the antimicrobial cleaning cloth, while the relative amount of the copper fibers in the antimicrobial cleaning cloth is up to substantially 29% (w/w).

According to one embodiment, the polyethylene terephthalate (PET) fibers and co-polyethylene terephthalate (CO-PET) fibers are configured to thermally bond other types of fibers of the nonwoven fabric in a process of thermal bonding.

According to one embodiment, the nonwoven fabric fibers comprise viscose fibers, and polypropylene fibers. According to another embodiment, the nonwoven fabric fibers comprise substantially 0-85% (w/w) viscose fibers of the entire fiber content of the antimicrobial cleaning cloth, substantially 0-50% (w/w) polypropylene fibers of the entire fiber content of the antimicrobial cleaning cloth, and substantially 0-60% (w/w) polyethylene terephthalate (PET) fibers of the entire fiber content of the antimicrobial cleaning cloth, while the relative amount of the copper fibers in the antimicrobial cleaning cloth is up to substantially 29% (w/w).

According to one embodiment, the nonwoven fabric fibers comprise viscose fibers, and thermally bonded fibers, also known as Thermobond. According to another embodiment, the nonwoven fabric fibers comprise substantially 5-85% (w/w) viscose fibers of the entire fiber content of the antimicrobial cleaning cloth, and substantially 5-50% (w/w) thermally bonded fibers, of the entire fiber content of the antimicrobial cleaning cloth, while the relative amount of the copper fibers in the antimicrobial cleaning cloth is up to substantially 29% (w/w).

According to one embodiment, the relative amounts of the nonwoven fabric fibers are such that they confer to the antimicrobial cleaning cloth the aforementioned characteristics, namely suitability for the manufacturing of cleaning cloths, suitability for the manufacturing of nonwoven fabric, conferring a desired degree of softness, conferring a desired degree of absorbability, and conferring a desired color.

According to one embodiment, the antimicrobial cleaning cloth further comprises active materials.

According to one embodiment, the active materials comprise for example surfactants, print materials and the like, and any combination thereof. According to another embodiment, the active materials comprise a watery dispersion comprising at least one of the following materials and any combination thereof: acrylic copolymers, anionic surfactants, nonionic surfactants, glycols, vax polyethylene, inorganic filling materials, anti-foaming materials, pH buffers and pigments. According to yet another embodiment, the relative amount of surfactants in the watery dispersion is in the range of substantially 1-5% (w/w).

The present subject matter further provides a method for manufacturing antimicrobial cleaning cloths, the method comprising:
mixing nonwoven fabric fibers and copper fibers;
carding the nonwoven fabric fibers and copper fibers;
cross-lapping the nonwoven fabric fibers and copper fibers;
needle-punching the nonwoven fabric fibers and copper fibers to form a nonwoven fabric comprising copper fibers;
slitting the nonwoven fabric comprising copper fibers to form nonwoven fabric sheets;
winding the nonwoven fabric sheets to form nonwoven fabric sheet rolls; and
cutting the nonwoven fabric sheet rolls to antimicrobial cleaning cloths.

According to one embodiment, the nonwoven fabric fibers are types of nonwoven fabric fibers according to embodiments described herein.

According to one embodiment, the carding the nonwoven fabric fibers and copper fibers comprises combing the fibers. According to another embodiment, the carding the nonwoven fabric fibers and copper fibers comprises opening and separating the nonwoven fabric fibers and copper fibers. According to yet another embodiment, the carding the nonwoven fabric fibers and copper fibers comprises producing of thin sheets of nonwoven fabric fibers and copper fibers.

According to one embodiment, the cross-lapping the nonwoven fabric fibers and copper fibers comprises dispersing the nonwoven fabric fibers and copper fibers in multiple layers in a desired width and weight.

According to one embodiment, the needle-punching the nonwoven fabric fibers and copper fibers comprises making a nonwoven fabric from nonwoven fabric fibers and copper fibers, by using needles that entangle the nonwoven fabric fibers and copper fibers.

According to one embodiment, the slitting the nonwoven fabric comprising copper fibers to form nonwoven fabric sheets comprises cutting the nonwoven fabric comprising copper fibers to pieces in desired sizes, that are suitable for the manufacture of cleaning cloths.

According to one embodiment, the method for manufacturing antimicrobial cleaning cloths further comprises after the needle-punching the nonwoven fabric fibers and copper fibers to form a nonwoven fabric comprising copper fibers—impregnating the nonwoven fabric comprising copper fibers with active materials. According to another embodiment, the impregnating the nonwoven fabric comprising copper fibers with active materials comprises dispersing the active materials over the nonwoven fabric comprising copper fibers. The active materials are described in detail above.

According to one embodiment, the method for manufacturing antimicrobial cleaning cloths further comprises after the impregnating the nonwoven fabric comprising copper fibers with active materials—drying the nonwoven fabric. According to another embodiment, the drying of the nonwoven fabric is performed at a temperature in a range of substantially 120-165° C.

According to one embodiment, the method for manufacturing antimicrobial cleaning cloths further comprises impregnating the nonwoven fabric comprising copper fibers with active materials once. According to another embodiment, the method for manufacturing antimicrobial cleaning cloths further comprises impregnating the nonwoven fabric comprising copper fibers with active materials once followed by drying the nonwoven fabric. According to yet another embodiment, the method for manufacturing antimicrobial cleaning cloths further comprises impregnating the nonwoven fabric comprising copper fibers with active materials at least once, preferably twice. According to still another embodiment, the method for manufacturing antimicrobial cleaning cloths comprises drying the nonwoven fabric comprising copper fibers at least after one of the impregnating the nonwoven fabric comprising copper fibers with active materials steps, preferably after each of the impregnating the nonwoven fabric comprising copper fibers with active materials steps.

According to one embodiment, the method for manufacturing antimicrobial cleaning cloths further comprises after the cutting the nonwoven fabric sheet rolls to antimicrobial cleaning cloths—packaging the antimicrobial cleaning cloths.

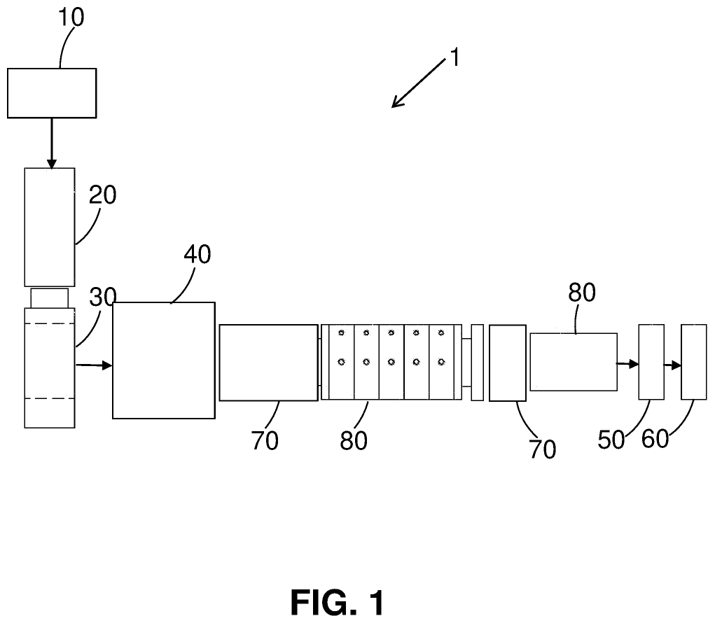

FIG. 1 schematically illustrates, according to an exemplary embodiment, a block diagram of a system for manufacturing antimicrobial cleaning cloths. The arrows in FIG. 1 indicate the direction of flow of the fabric materials through the system.

According to one embodiment, the system 1 for manufacturing antimicrobial cleaning cloths comprises:
a fiber feeding element 10 configured to feed nonwoven fabric fibers and copper fibers according to embodiments described herein into a carding element 20;
a carding element 20 after the fiber feeding element, the carding element 20 configured to card the nonwoven fabric fibers and copper fibers according to embodiments described herein;
a cross-lapping element 30 after the carding element 20, the cross-lapping element 30 configured to cross-lap the nonwoven fabric fibers and copper fibers according to embodiment described herein;
a needle-punching element 40 after the cross-lapping element 30, the needle-punching element 40 configured to needle-punch the nonwoven fabric fibers and copper fibers to form a nonwoven fabric comprising copper fibers according to embodiments described herein;
a slitting element 50 after the needle-punching element 40, the slitting element 50 configured to slit the nonwoven fabric comprising copper fibers to form nonwoven fabric sheets according to embodiments described herein; and
a winding element 60 after the slitting element 50, the winding element 60 configured to wind the nonwoven fabric sheets to form nonwoven fabric sheet rolls according to embodiments described herein.

According to one embodiment, the system 1 for manufacturing antimicrobial cleaning cloths further comprises an impregnating element 70 after the needle-punching element 40, the impregnating element 70 configured to impregnate the nonwoven fabric with active materials according to embodiments described herein.

According to one embodiment, the system 1 for manufacturing antimicrobial cleaning cloths further comprises a drying element 80 after the impregnating element 70, the drying element 80 configured to dry the nonwoven fabric after impregnating the nonwoven fabric.

According to one embodiment, the system 1 for manufacturing antimicrobial cleaning cloths further comprises at least one impregnating element 70 after the needle-punching element 40, the at least one impregnating element 70 configured to impregnate the nonwoven fabric with active materials according to embodiments described herein.

According to one embodiment, the system 1 for manufacturing antimicrobial cleaning cloths further comprises a drying element 80 at least after one of each of the at least one impregnating element 70, preferably after each of all of the at least one impregnating element 70.

According to one embodiment, the system 1 for manufacturing antimicrobial cleaning cloths further comprises multiple consecutive impregnating elements 70 after the needle-punching element 40, preferably two consecutive impregnating elements 70, the multiple consecutive impregnating elements 70 configured to impregnate the nonwoven fabric with active materials according to embodiments described herein.

According to one embodiment, the system 1 for manufacturing antimicrobial cleaning cloths further comprises a drying element 80 at least after one of each of the multiple consecutive impregnating elements 70, preferably after each of all of the multiple consecutive impregnating elements 70.

According to one embodiment, the system 1 for manufacturing antimicrobial cleaning cloths further comprises a cutting element after the winding element 60, the cutting element configured to cut the nonwoven fabric sheet rolls to antimicrobial cleaning cloths according to embodiments described herein.

According to one embodiment, the system 1 for manufacturing antimicrobial cleaning cloths further comprises a packaging element after the cutting element, the packaging element configured to package the antimicrobial cleaning cloths.

It is appreciated that certain features of the subject matter, which are, for clarity, described in the context of separate embodiments, may also be provided in combination in a single embodiment. Conversely, various features of the subject matter, which are, for brevity, described in the context of a single embodiment, may also be provided separately or in any suitable sub combination.

Although the subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. An antimicrobial cleaning cloth comprising:
nonwoven fabric fibers; and
copper fibers.

2. The antimicrobial cleaning cloth of claim 1, wherein the nonwoven fabric fibers comprising viscose fibers, polyethylene terephthalate fibers, and co-polyethylene terephthalate fibers.

3. The antimicrobial cleaning cloth of claim 1, wherein the nonwoven fabric fibers comprising viscose fibers, and polypropylene fibers.

4. The antimicrobial cleaning cloth of claim 1, wherein the nonwoven fabric fibers comprising viscose fibers, and thermally bonded fibers.

5. The antimicrobial cleaning cloth of claim 1, further comprising active materials.

6. A method for manufacturing antimicrobial cleaning cloths, the method comprising:
mixing nonwoven fabric fibers and copper fibers;
carding the nonwoven fabric fibers and copper fibers;
cross-lapping the nonwoven fabric fibers and copper fibers;
needle-punching the nonwoven fabric fibers and copper fibers to form a nonwoven fabric comprising copper fibers;
slitting the nonwoven fabric comprising copper fibers to form nonwoven fabric sheets;
winding the nonwoven fabric sheets to form nonwoven fabric sheet rolls; and
cutting the nonwoven fabric sheet rolls to antimicrobial cleaning cloths.

7. The method for manufacturing antimicrobial cleaning cloths of claim 1, further comprising after the needle-punching the nonwoven fabric fibers and copper fibers to form a nonwoven fabric comprising copper fibers—impregnating the nonwoven fabric comprising copper fibers with active materials.

8. The method for manufacturing antimicrobial cleaning cloths of claim 6, further comprising after the impregnating the nonwoven fabric comprising copper fibers with active materials—drying the nonwoven fabric.

9. The method for manufacturing antimicrobial cleaning cloths of claim 8, wherein the drying of the nonwoven fabric is performed at a temperature in a range of substantially 120-165° C.

10. The method for manufacturing antimicrobial cleaning cloths of claim 6, further comprising after the cutting the nonwoven fabric sheet rolls to antimicrobial cleaning cloths—packaging the antimicrobial cleaning cloths.

11. A system for manufacturing antimicrobial cleaning cloths comprising:
a fiber feeding element configured to feed nonwoven fabric fibers and copper fibers into a carding element;
a carding element after the fiber feeding element, the carding element configured to card the nonwoven fabric fibers and copper fibers;
a cross-lapping element after the carding element, the cross-lapping element 30 configured to cross-lap the nonwoven fabric fibers and copper fibers;
a needle-punching element after the cross-lapping element, the needle-punching element configured to needle-punch the nonwoven fabric fibers and copper fibers to form a nonwoven fabric comprising copper fibers;
a slitting element after the needle-punching element, the slitting element configured to slit the nonwoven fabric comprising copper fibers to form nonwoven fabric sheets; and
a winding element after the slitting element, the winding element configured to wind the nonwoven fabric sheets to form nonwoven fabric sheet rolls.

12. The system for manufacturing antimicrobial cleaning cloths of claim 11, further comprising at least one impregnating element after the needle-punching element, the at least one impregnating element configured to impregnate the nonwoven fabric with active materials.

13. The system for manufacturing antimicrobial cleaning cloths of claim 12, further comprising a drying element after the impregnating element, the drying element configured to dry the nonwoven fabric after impregnating the nonwoven fabric.

14. The system for manufacturing antimicrobial cleaning cloths of claim 11, further comprising a cutting element after the winding element, the cutting element configured to cut the nonwoven fabric sheet rolls to antimicrobial cleaning cloths.

15. The system for manufacturing antimicrobial cleaning cloths of claim 14, further comprising a packaging element after the cutting element, the packaging element configured to package the antimicrobial cleaning cloths.
